(19) United States
(12) Patent Application Publication
(10) Pub. No.: US 2017/0283293 A1
(43) Pub. Date: Oct. 5, 2017

(54) METHOD FOR RECYCLING BYPRODUCT SLUDGE IN RECYCLED AGGREGATE PRODUCING PROCESS FROM WASTE CONCRETE

(71) Applicant: KOREA INSTITUTE OF GEOSCIENCE AND MINERAL RESOURCES (KIGAM), Daejeon (KR)

(72) Inventors: Hee-Young SHIN, Daejeon (KR); Sang-woo JI, Daejeon (KR); Young-soo HAN, Daejeon (KR)

(21) Appl. No.: 15/381,177

(22) Filed: Dec. 16, 2016

(30) Foreign Application Priority Data
Mar. 31, 2016 (KR) 10-2016-0039011

(51) Int. Cl. C02F 11/12; C04B 7/40; C02F 11/14

(52) U.S. Cl. CPC C02F 11/121; C02F 11/14; C04B 7/40; C02F 2101/10

(57) ABSTRACT

The present disclosure relates to a method for treating and recycling, in an environment-friendly manner, sludge and waste water generated in a process for crushing waste concrete and recycling waste concrete into aggregates. Sand is separated from sludge configured from cement components and sand components and is recycled as fine aggregates, and the cement components can be used as concrete admixtures. Furthermore, the present invention introduces a mineral carbonation technique and thereby allows pH of waste water to satisfy an environmental standard and allows high value calcium carbonate to be produced.

### CROSS-REFERENCE TO RELATED APPLICATION

This application claims priority to Korean Patent Application No. 10-2016-0039011 filed on Mar. 31, 2016 and all the benefits accruing therefrom under 35 U.S.C. §119, the contents of which are incorporated by reference in their entirety.

### BACKGROUND

The present disclosure relates to a technique of recycling materials for construction and civil engineering, and more particularly, to a method for recycling byproduct generated in a process for producing recycled aggregates by recycling waste concrete which is construction waste.

Aggregates produced by recycling waste concrete are referred to as circulation aggregates. The circulated aggregates are classified into a rough circulated aggregates and fine aggregates according to sizes thereof. A method for producing circulated fine aggregates is a process, as illustrated in a process chart of FIG. 1, in which a process of crushing waste concrete using a plurality of crushers and screens and classifying the crushed concrete according to particle sizes is repeated, and finally, the particle sizes of aggregates are matched to predetermined specifications. The crushing and particle-size classification are not performed at once but performed in a continuous and repeated manner. Accordingly, in typical processes, improving crushing efficiency is the most important technical issue.

As described above, a byproduct, that is sludge, is generated in a process of recycling waste concrete. The sludge is generated in processes of recycling waste concrete, in particular, in processes using water, such as washing processed. That is, micro particles of waste concrete are mixed with water to form sludge.

There is a problem in that an amount of solid components (waste concrete micro particles) is very great to range from approximately 25% to approximately 35% with respect to the total waste concrete to be recycled. The more active the recycling of waste concrete, the greater the amount of sludge increases together. It is desirable that a recycling rate of waste concrete increase. The remaining problem is to develop a technique of treating and recycling sludge generated in processes of recycling waste concrete.

Meanwhile, when waste concrete sludge is not recycled but discarded as in typical arts, sludge is first dehydrated. The water discharged after undergoing dehydration process exhibits a strong basic property of PH12 or more, and when the water is discharged without any treatment, there is a problem in that the water acts as an environment-polluting source.

### SUMMARY

The present disclosure provides a method for recycling waste concrete sludge, wherein sludge with high moisture content generated in a process for recycling waste concrete is recycled as a construction material and pH of discharged water can be decreased in the process.

Other purposes that are not described in the description can be taken into account in the scope of the present invention and their effects provided in the following description

In accordance with an exemplary embodiment of the present invention, a method for treating and recycling sludge generated in a process of producing recycled aggregates from waste concrete.

In accordance with an exemplary embodiment of the present invention, a method includes: separating sludge containing waste concrete fine powder and water into overflow products having relatively small particle sizes using a cyclone apparatus and underflow products having relatively great particle sizes; dehydrating the overflow products and thereby separating waste water and sludge cakes from each other; supplying carbon dioxide in the waste water and carbonating and depositing alkali earth metal ions in the waste water; and separating calcium carbonate and waste water through solid-liquid separation.

The underflow products discharged from the cyclone apparatus may be recycled as materials for civil engineering and construction such as ascon materials, cement admixtures, and fine aggregates.

In the separating of sludge, particle sizes of the overflow products may have a mass median diameter d50, at which accumulated particle distribution value reaches approximately 50%, greater than a range from approximately 20 μm to approximately 40 μm. For example, an operation condition of the cyclone apparatus may be adjusted, and the separating of particle sizes may be performed such that the underflow products satisfy d50>30 μm, and the overflow products satisfy d50<30 μm.

The underflow products may be dehydrated in the separating of sludge using the cyclone apparatus and moisture content may thereby be decreased. For example, initial sludge may have a moisture content of approximately 80 wt % or more, and the underflow products may have moisture contents of approximately 60 wt % or less. In the current embodiment, initial sludge may have a moisture content of approximately 95%, and the underflow products may have moisture contents less than approximately 50%.

A calcium content in waste concrete fine powder in the sludge may be approximately 10 wt % or more, and a concentration of calcium ion in the waste water may be in a range from approximately 400 mg/L to approximately 1000 mg/L before carbon dioxide is supplied.

Carbon dioxide collected from exhaust gas of a power plant may be used as the carbon dioxide, and the carbon dioxide may be supplied as a bubble shape having a micro size.

The waste water discharged through solid-liquid separation after the deposition of alkali earth metal may have pH of approximately 5.8 to approximately 8.5.

The alkali earth metal may be calcium, and a precipitate may be calcium carbonate having a purity of approximately 95% or more.

### BRIEF DESCRIPTION OF THE DRAWINGS

Exemplary embodiments can be understood in more detail from the following description taken in conjunction with the accompanying drawings, in which:

FIG. 1 is a schematic process chart for recovering waste concrete according to typical arts;

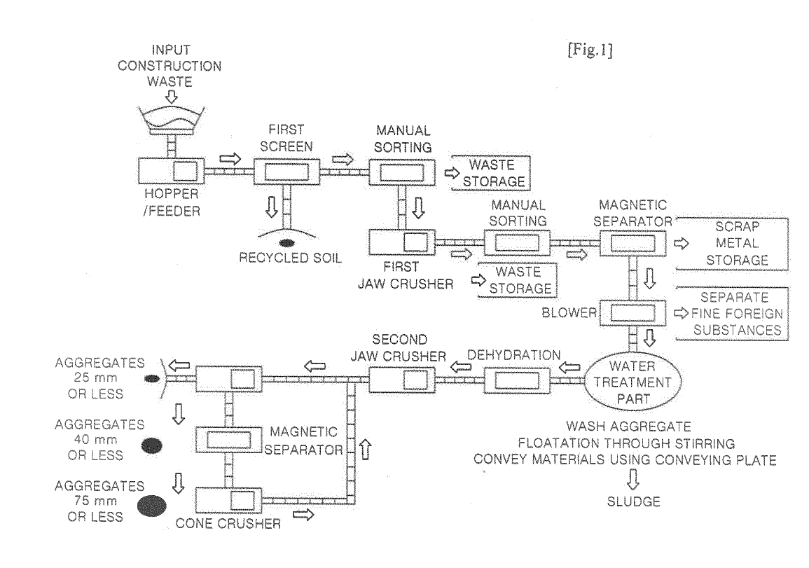

FIG. 2 is a schematic flowchart illustrating a method of recycling sludge in producing recycled aggregates according to an embodiment of the present invention;

FIG. 3 is a view for illustrating a wet-type cyclone apparatus used in the present invention;

FIG. 4 is a photograph of calcium carbonate deposited by supplying carbon dioxide in waste water;

FIG. 5 is a analysis result for calcium carbonate shown in the photograph of FIG. 4;

FIG. 6 is a table illustrating a change in pH of waste water while a mineral carbonation reaction is performed; and

FIG. 7 is a table tracking a change in pH of waste water for a predetermined time after a mineral carbonation reaction is completed.

The attached drawings are merely an example for specifically describing the inventive concept of the present invention, and the scope of the present invention is not limited by the attached drawings.

### DETAILED DESCRIPTION OF EMBODIMENTS

In the following description of the present invention, a detailed description of known functions and configurations which are obvious to those skilled in the art will be omitted when it may unnecessarily make the subject matter of the present invention rather unclear.

The present disclosure relates to a method for treating and recycling sludge generated in a process for recycling waste concrete into circulated aggregates (or recycled aggregates).

Although described in background, since processes of crushing, separating according to particle sizes, and washing are repeatedly performed in producing circulated aggregates, waste concrete fine powder with a very high moisture content is generated. This is referred to as “recycled aggregate sludge.

Waste concrete is a combination of rough aggregates, fine aggregates, and cement, and since the rough aggregates are reproduced into circulated aggregates in a recycling process, recycled aggregate sludge is mainly configured from sand components (fine aggregates) and cement components.

In typical processes of producing recycled aggregates, it is impossible to separate, from each other, sand components and cement components in the recycled aggregate sludge through screening using a screen. In addition, particle sizes of sludge are mostly approximately 0.075 mm or less, but components with sizes of approximately 0.03 mm or less are difficult to be used as aggregates due to too small particle sizes. For such reasons, sludge generated in the recycled aggregate producing process was all discarded.

Also, since sludge has a very high moisture content which exhibiting a strong alkaline property, there is a remaining difficult problem in discharging sludge as it is. A method of decreasing alkalinity by adding acid is not appropriate. This is because, alkalinity is decreased temporarily by adding acid, but alkaline materials in cement fine powder are eluted by the acid, thereby increasing alkalinity again.

The present disclosure provides a method which can simultaneously address such problems.

Although not limited in moisture contents, sludge having a moisture content of approximately 80% or more, or sludge having a more moisture content of approximately 95% or more can also be used as sludge to be recycled in the present invention.

Also, such sludge contains a cement component, and thereby contains a calcium component. Although there is no limit to calcium content, when considering efficiency of later mineral carbonation, it is desirable that solid components (waste concrete fine powder) of sludge contain approximately 10 wt % or more of calcium.

Hereinafter, with reference to accompanying drawings, a method of recycling sludge generated in a process of recycling waste concrete and a method of treating discharged water (hereinafter, referred to as “sludge recycling method”) will be described in detail.

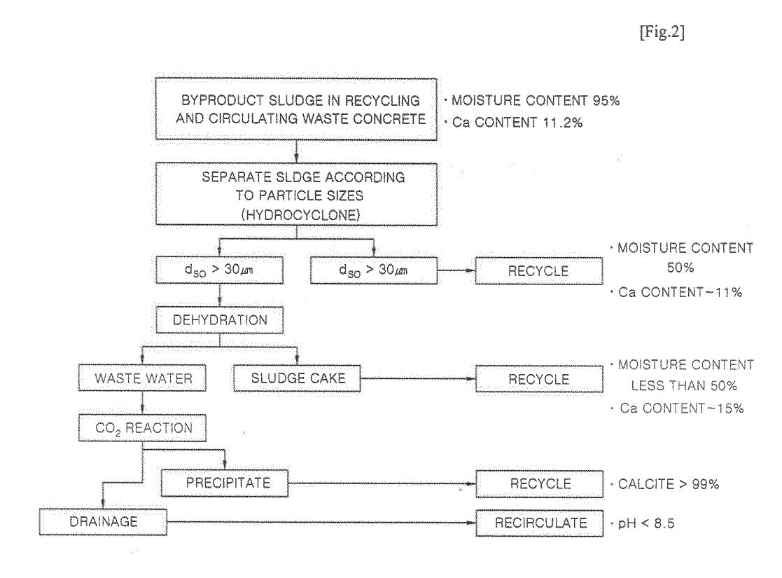

FIG. 2 is a schematic flowchart illustrating a method of recycling sludge according to an embodiment of the present invention.

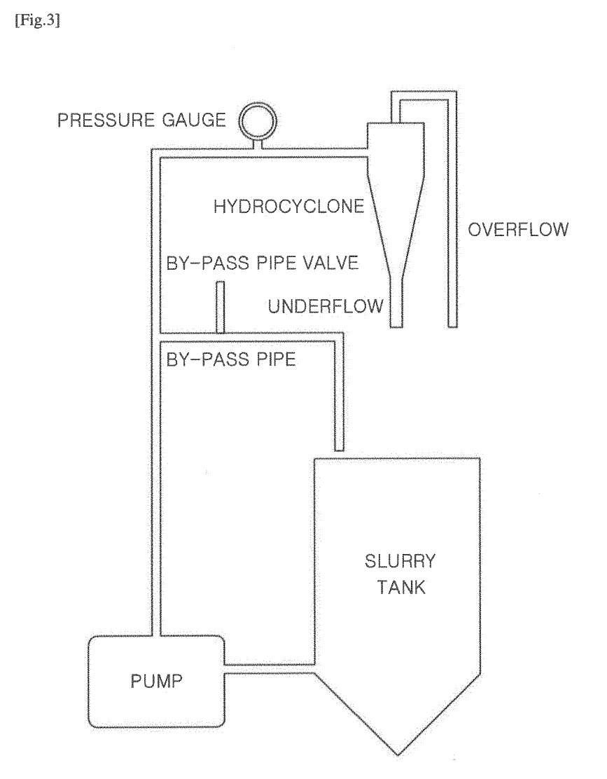

Referring to FIG. 2, in a method of recycling sludge according to the present invention, sludge is firstly separated according to particle sizes through a wet-type cyclone apparatus (see FIG. 3). Since sludge has a high moisture content, water is not separately added. But according to operation conditions, water is added and a cyclone apparatus may also be used.

As illustrated in FIG. 3, the wet-type cyclone apparatus is provided with a slurry tank, a pump, and a cone-shaped cyclone apparatus. The cyclone apparatus has a conic shape and upper and lower portions which are opened. Sludge is transferred by the pump and then introduced into an upper side surface of sludge with a high speed. Since sludge is introduced in a tangential direction to the cyclone apparatus, while sludge rotates moves down in the circumferential direction inside a cyclone, components having small weights and particle sizes ride a rising current of air to be upwardly discharged (overflow), and components having relatively great weights and particle sizes are downwardly discharged (underflow). Water contained in sludge is discharged as overflow. Such a principle of wet-type cyclone apparatus is well known, and therefore, more detailed description thereof will not be further provided.

In the present invention, operating conditions (sludge introduction condition, concentration of ore solution) of the cyclone apparatus are adjusted according to usage of recycling sludge and the criteria of particle size classification may be adjusted. In the current embodiment, after separating sludge according to particle sizes, the criteria of the particle sizes of the overflow products and the underflow products was set to d50 value (mass median diameter) of approximately 30 μm. For example, the underflow products can be divided according to particle sizes, and from among the total underflow products, approximately 50 wt % of particles are distributed at approximately 30 μm or more in a particle size distribution. This is described as “d50>30 μm”. Conversely, the overflow products satisfy d50<30 μm. From among the products having small particle sizes, at a point reaching approximately 50% of the total weight, the particle size is approximately 30 μm or less. In the current embodiment, the reference of d50 is set to approximately 30 μm, but may be set to a wider range from approximately 20 μm to approximately 40 μm.

As described above, the cyclone apparatus is operated such that d50 of the overflow products and the underflow products are respectively set to a criterion of 30 μm. In the current embodiment, it is determined that when sludge satisfy d50 >30 μm, the sludge can be recycled as fine aggregates, and the condition of the cyclone apparatus was found through an experiment such that separating according to particle sizes is performed to match the criteria. The condition found through the experiment was an ore liquid concentration of approximately 5%, and an injection pressure of approximately 0.2 MPa to approximately 0.3 MPa in a 2-inch cyclone apparatus, and when operated under the above condition, the cyclone apparatus could satisfy the particle size criteria.

In the present invention, the underflow products which are separated according to particle sizes through the cyclone apparatus are recycled as materials for construction or civil engineering, such as ascon materials or cement admixtures. Since having main components of sand components except for cement components from sludge, these may be recycled as construction materials such as aggregates.

Also, as described above, when the separating of sludge according to particle sizes is performed by using the cyclone apparatus, there is a sub effect in that the underflow products are dehydrated. That is, water contained in sludge has a light weight, and is therefore overflowed in the cyclone apparatus. Accordingly, the underflow products have a decreased moisture content. When the cyclone was operated under the same condition as those in the current embodiment, the moisture content was formed at an average of approximately 50% or less. Even in an example in which dehydration was performed least, the moisture content was maintained at approximately 60% or less. Accordingly, when the wet-type cyclone apparatus was used, the moisture contents of the underflow products was decreased. Thus, it could be ensured that a dehydration process can be more easily performed in using the products as construction materials.

As described above, after the separation of sludge according to particle sizes arc completed, a dehydration process is performed with respect to the overflow products. The dehydration may be performed through various well-known apparatuses such as centrifugal separator. Undergoing the dehydration, the overflow products are divided into a sludge cake and waste water. Through the dehydration process, the moisture content of the sludge cake is favorably made to be approximately 50% or less and at least approximately 60% or less. The sludge cake is mainly fine powder with sizes of approximately 0.03 mm or less, and mainly has a greater calcium content. Components constituting the sludge cake have too small particle sizes, and are therefore difficult to be used as aggregates, but can be used as cement admixtures after being dried. When used as cement admixtures, particles with a small particle sizes have greater specific surface areas to thereby have excellent reactivity, and is therefore advantageous.

Meanwhile, the present invention places more emphasis on waste water generated through the dehydration process. This waste water has a very high alkalinity exceeding pH12 and therefore, is not suitable to effluent standards. All waste water generated in a process of producing recycled aggregates also exhibits alkalinity. One more characteristic is calcium ions are much included in waste water. In the current embodiment, the calcium content was analyzed to be approximately 700 mg/L. From the experimental results with respect to various samples, it was analyzed that waste water dehydrated from sludge contained approximately 400 mg/L to approximately 1,000 mg/L of calcium ions in a wide case, and approximately 500 mg/L to approximately 800 mg/L of calcium ions in a narrow case. Of course, a high concentration of approximately 1,000 mg/L or more is further more effective in the present invention. For this, in an embodiment of the present invention, limestone or limestone powder may be separately input to waste water.

In the present invention, mineral carbonation technique is introduced in order to treat waste water exhibiting very strong alkalinity and containing a great amount of calcium ions. That is, the mineral carbonation technique refers to a technique in which carbon dioxide is supplied to alkali earth metal, such as calcium or magnesium, and the resultant is made into calcium carbonate. In particular, exhaust gas of power plant or the like or a concentrate thereof may be used.

The mineral carbonation technique may be divided into a direct method in which a starting material made into a solid state is reacted with carbon dioxide and an indirect method in which calcium or magnesium is eluted from a starting material by using acid or the like and then carbon dioxide is supplied to react the resultant. In the mineral carbonation technique, the indirect method has a remarkably greater efficiency, but in the indirect method, pH should be decreased by using acid to elute calcium and then pH should be increased by inputting alkaline agent again. This is because the calcium carbonate is actively formed under an alkaline condition. Since both acid and base should be used, it was indicated that there is a big problem of degrading economic feasibility.

However, the problematic points in the indirect method for mineral carbonation can be all resolved in waste water generated as an intermediate product in the recycling method according to the present invention. That is, this is because waste water forms a high alkaline condition and a great amount of calcium ions are eluted. A state similar to that in which pH is increased by inputting alkaline material after calcium is eluted through the indirect method has been formed.

Accordingly, in the present invention, carbon dioxide is supplied to waste water, and calcium carbonate is allowed to be formed such that calcium ions in waste water and carbon dioxide react as following reaction formulae (1) and (2).

CO₂+H₂O=—HCO₃⁻+H⁺ (1)

Ca²⁺HCO₃⁻=CaCO₃+H⁺ (2)

Referring to above reaction formulae, carbon dioxide is separated into carbonic acid and hydrogen in waste water. Carbonic acid is combined with calcium to form calcium carbonate and is deposited, and hydrogen ions remain in waste water.

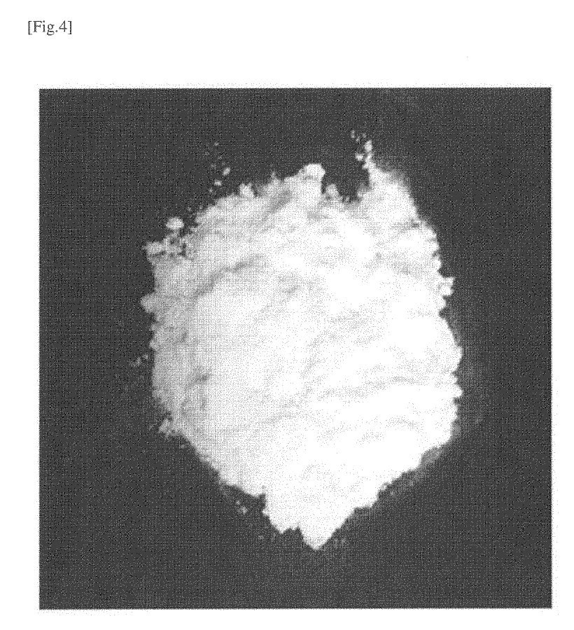

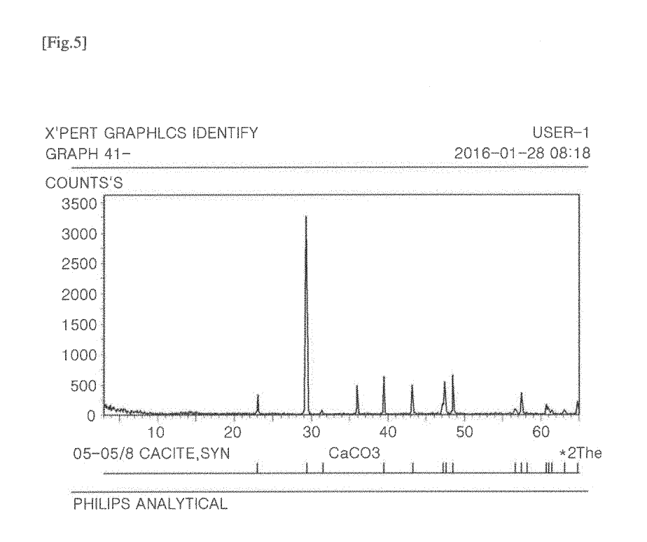

In the sludge recycling method according to present invention, the mineral carbonation technique is introduced and thus there is a merit in that calcium in waste water is deposited as calcium carbonate and can thereby be recycled. The photograph of FIG. 4 illustrates a precipitate formed by supplying carbon dioxide in waste water, and FIG. 5 illustrates an XRD analysis results for this precipitate. Referring to the XRD analysis result of FIG. 5, the precipitate was identified as calcite of high-purity of approximately 99% or more. Like the present invention, when the indirect method in which carbon dioxide is supplied in a state in which calcium ions are eluted, the calcium carbonate precipitate can maintain a purity of approximately 95% or more.

Calcium carbonate should satisfy three conditions to be a high value material. The three conditions are high purity, high whiteness, and low granularity. Calcium carbonate deposited in the above experiment satisfies a high purity of approximately 99% or more. Also, as illustrated in the photograph of FIG. 4, the calcium carbonate has excellent whiteness and may thereby be recycled as a high-grade material used for paper making. Furthermore, in the current embodiment, carbon dioxide is supplied as a bubble shape with micro sizes, and thus, not only a fixation rate of carbon dioxide in increased but also particle sizes of deposited calcium carbonate become small. That is, both high purity and low granularity are satisfied.

In the present invention, the mineral carbonation technique is applied to waste water, and thus, carbon dioxide is fixed in calcium carbonate. Thus, there are merits in that not only certified emission reduction which can be traded can be obtained but also high value calcium carbonate with high purity, high whiteness, and fine particle sizes can be produced and recycled.

A more important point is that the waste water discharge problem which was the problem in typical processes of recycled aggregates is resolved. That is, since hydrogen ions are generated as the above reaction formula 2 in the mineral carbonation reaction, pH of waste water is decreased and thereby can satisfy the effluent standards of pH level of approximately 5.8 to approximately 8.5. Waste water treatment has been a very big problem in that environment friendliness and economic feasibility are degraded in recycling process of waste concrete, but this problem can be resolved at once by introducing the mineral carbonation technique.

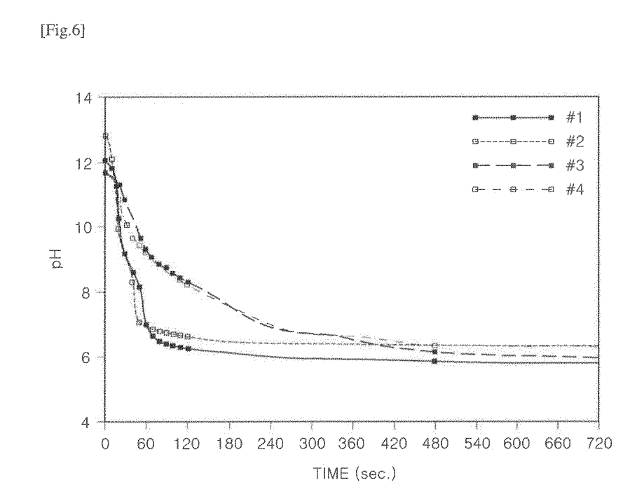

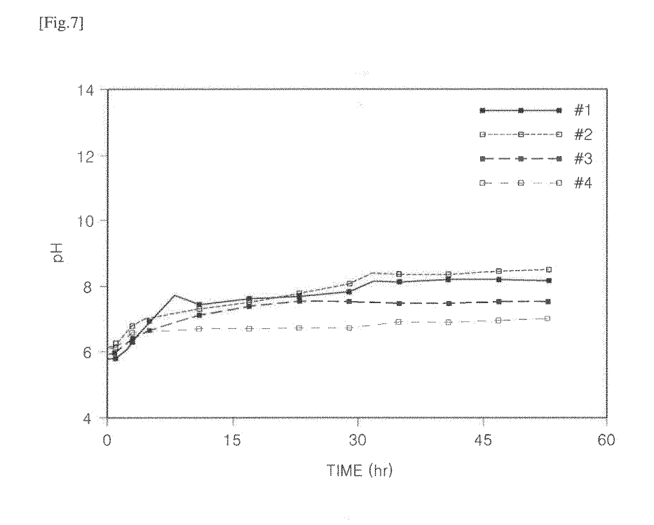

Researchers of the present invention performed an experiment on a change in pH of waste water according to a mineral carbonation reaction. Firstly, carbon dioxide was injected in waste water and a change in pH of waste water in a process of the mineral carbonation reaction. The result is illustrated in the table in FIG. 6. In addition, whether pH is recovered after completing the mineral carbonation reaction was examined. The result is illustrated in the table in FIG. 7.

Also, in the current experiment, the separation of sludge according to particle sizes was not performed like in the present invention, and waste water itself generated in recycling process of waste concrete, that is raw water, was examined whether the mineral carbonation technique can be applied to the water. This is because calcium was also dissolved in raw water and the raw water had strong alkalinity and thereby it was determined that the mineral carbonation technique can be applied to the raw water.

In the table of FIG. 6 and the table of FIGS. 7, #1 and #2 refer to supernatant water which was dehydrated from overflow products undergone the separating sludge according to particle sizes as in the present invention, and #3 and #4 refer to raw water used as washing water in a recycling process of waste concrete without the above process.

Referring to the table of FIG. 6, it can be understood that both the supernatant water and the raw water exceed pH12 before a mineral carbonation reaction occurs. However, as the mineral carbonation reaction starts, pH was decreased to approximately pH8.5 or less within approximately 1 minute, and then converged to approximately pH 6.2. The decreasing speed of pH for raw water is slower than that for supernatant water. This is because impurities or the like seem to act as factors of obstruction against the mineral carbonation reaction. However, it was confirmed that raw water also converged so as to satisfy pH of approximately 5.8 to approximately 8.5 which is an effluent standard only with difference in time. Also for raw water, pH will be decreased in a shorter time when undergoing screening and filtering for removing impurities.

Also, referring to the table of FIG. 7, whether is recovered is confirmed for approximately 60 hours after a mineral carbonation reaction is completed by stopping supplying carbon dioxide. It was understood that although slightly increased, pH was at a level satisfying an effluent standard.

Referring to above-mentioned result, according to the present invention, it was confirmed that there were many merits when recycled aggregate sludge was separated according to particle sizes, and then underflow components with greater particle sizes were recycled as materials for construction and civil engineering, such as aggregates, and the overflow components were dehydrated and then a mineral carbonation technique was applied to waste water.

Carbon dioxide is fixed to minerals and thus, it is possible to cope with environmental problems, trade certified emission reduction, form and recycle high value calcium carbonate, and adjust pH so as to satisfy an environmental standard of effluent of waste water.

Meanwhile, referring to the above experimental results, in the present invention, it was confirmed that the mineral carbonation technique could also be applied to waste water (raw water) such as washing water directly generated in recycling process of waste concrete aside from waste water separated in a dehydration process after separating sludge according to particle sizes. Carbon dioxide is individually supplied only to raw water and thus, it is expected that pH can also he reduced and a process can also be integrated by mixing with supernatant water.

Meanwhile, as described above, waste water and precipitates are subjected to solid-liquid separation after the mineral carbonation reaction is performed with respect to waste water. The solid-liquid separation may be performed through various well-known apparatuses, such as a centrifugal separator or a screen.

In addition, finally separated waste water has decreased pH and may be discharged, but is used again in a recycling process of waste concrete and thus, a circulation process may be formed.

The present invention provides a method capable of recycling again concrete fine powder which is generated in a process of making waste concrete into circulated aggregates and has very high moisture content, and thus a recycling amount with respect to the total waste concrete may be improved.

First of all, there is a merit in that pH of waste water exhibiting strong alkaline property is decreased in a process for recycling sludge and is thereby formed suitable to effluent standards.

In addition, in the present invention, carbon dioxide is supplied to waste water in the recycling process to perform mineral carbonation, and there is a merit in that carbon dioxide which is the subject of certified emission reduction can be effectively fixed.

In addition, even though not specifically mentioned herein, the effects described in the specifications below and expected in accordance with technical features of the present invention and provisional effects thereof may be treated as disclosed in the specification of the present invention.

The protective scope of the present invention is not limited to the description and expression in embodiments specifically described above. Furthermore, the protective scope of the present invention could not also be limited due to obvious changes or replacements in the technical field of the present invention.

What is claimed is:

1. A method for recycling sludge in producing recycled aggregates, the method comprising:
(a) separating sludge containing waste concrete micro powder and water into overflow products having relatively small particle sizes using a cyclone apparatus and underflow products having relatively great particle sizes;
(b) dehydrating the overflow products and thereby separating waste water and sludge cakes from each other;
(c) supplying carbon dioxide in the waste water and carbonating and depositing alkali earth metal in the waste water; and
(d) separating alkali earth metal carbonate and waste water through solid-liquid separation.

2. The method for recycling sludge in producing recycled aggregates of claim 1, wherein the underflow products discharged from the cyclone apparatus are recycled as materials for civil engineering and construction, such as ascot materials.

3. The method for recycling sludge in producing recycled aggregates of claim 1, wherein in the separating of sludge, particle sizes of the overflow products have a mass median diameter d50, at which accumulated particle distribution value reaches approximately 50%, greater than a range of approximately 20 μm.

4. The method for recycling sludge in producing recycled aggregates of claim 1, wherein the underflow products are dehydrated in the separating of sludge using the cyclone apparatus and a moisture content is thereby be decreased.

5. The method for recycling sludge in producing recycled aggregates of claim 4, wherein the sludge has a moisture content of approximately 80 wt % or more, and the underflow products have moisture contents of approximately 60 wt % or less.

6. The method for recycling sludge in producing recycled aggregates of claim 1, wherein a calcium content in waste concrete fine powder in the sludge is approximately 10 wt % or more.

7. The method for recycling sludge in producing recycled aggregates of claim 6, wherein a concentration of calcium ion in the waste water is in a range from approximately 400 mg/L to approximately 1000 mg/L before carbon dioxide is supplied.

8. The method for recycling sludge in producing recycled aggregates of claim 1, wherein carbon dioxide is collected from exhaust gas of a power plant.

9. The method for recycling sludge in producing recycled aggregates of claim 1, wherein carbon dioxide is supplied as a bubble shape with a size of micrometers.

10. The method for recycling sludge in producing recycled aggregates of claim 1, wherein the waste water discharged through solid-liquid separation after depositing alkali earth metal has pH of approximately 5.8 to approximately 8.5.

11. The method for recycling sludge in producing recycled aggregates of claim 1, wherein the alkali earth metal is calcium, and a precipitate is calcium carbonate having a purity of approximately 95% or more.

12. The method for recycling sludge in producing recycled aggregates of claim 1, wherein in step (c), raw water generated in a recycling process of waste concrete, containing calcium, and exhibiting alkalinity is mixed with waste water.

13. The method for recycling sludge in producing recycled aggregates of claim 12, wherein suspended substances are removed from the raw water through filtering.
